(19) United States
(12) Patent Application Publication
(10) Pub. No.: US 2014/0337900 A1
(43) Pub. Date: Nov. 13, 2014

(54) Interactive Video

(71) Applicant: MixBit, Inc., San Mateo, CA (US)

(72) Inventor: Chad M. Hurley, Atherton, CA (US)

(73) Assignee: MixBit, Inc., San Mateo, CA (US)

(21) Appl. No.: 14/274,520

(22) Filed: May 9, 2014

Related U.S. Application Data
(60) Provisional application No. 61/821,646, filed on May 9, 2013.

(51) Int. Cl. H04N 21/235; H04N 21/858; H04N 21/81

(52) U.S. Cl. CPC H04N 21/235; H04N 21/812; H04N 21/858
USPC 725/87

(57) ABSTRACT

A person's video watching experience is enhanced. A request is received to play a video. In response to the request, a device is used to play the video to the person. In response to playing of the video, an event outside the video that is related to the video and affects the person is initiated.

### RELATED APPLICATION

This application claims the benefit of U.S. Provisional Application No. 61/821,646, filed May 9, 2013, which is incorporated by reference herein in its entirety.

### BACKGROUND

1. Technical Field

This technology relates generally to using videos to initiate other actions or events outside the video, for example to create a more immersive and/or interactive experience.

2. Background Information

When a video is watched using conventional technologies, the experience is generally passive. A person watches the video and, other than changing settings relating to the video (size, resolution, audio volume, etc.), does not interact with the video. Further, the device on which the video is played is typically static during the video as well as between different videos.

### SUMMARY

The above and other issues are addressed by a method, non-transitory computer-readable storage medium, and system for enhancing a person's video watching experience. An embodiment of the method comprises receiving a request to play a video. The method further comprises, in response to the request, using a device to play the video to the person. The method further comprises, in response to playing of the video, initiating an event outside the video that is related to the video and affects the person.

An embodiment of the medium stores computer program modules executable to perform steps. The steps comprise receiving a request to play a video. The steps further comprise, in response to the request, using a device to play the video to the person. The steps further comprise, in response to playing of the video, initiating an event outside the video that is related to the video and affects the person.

An embodiment of the system comprises a non-transitory computer-readable storage medium storing computer program modules executable to perform steps. The steps comprise receiving a request to play a video. The steps further comprise, in response to the request, using a device to play the video to the person. The steps further comprise, in response to playing of the video, initiating an event outside the video that is related to the video and affects the person.

Other aspects include systems, methods, devices, components, applications, and other technologies and embodiments related to the foregoing and its variations and improvements. The features and advantages described in the specification are not all-inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF THE DRAWINGS

The patent or application file contains at least one drawing executed in color. Copies of this patent or patent application publication with color drawings will be provided by the U.S. Patent and Trademark Office upon request and payment of the necessary fee.

The technology has other advantages and features which will be more readily apparent from the following detailed description and the appended claims, when taken in conjunction with the accompanying drawings, in which:

FIG. 1 is a flow diagram illustrating actions and events initiated by playing a video, in accordance with an embodiment.

FIGS. 2A-2B are two screen images showing the background of a webpage changing in response to the colors present in the video being played on the webpage, in accordance with an embodiment.

FIG. 3 is a flow diagram illustrating a “choose your own adventure” video, in accordance with an embodiment.

FIG. 4 is a flow diagram illustrating viewer-determined content, in accordance an embodiment.

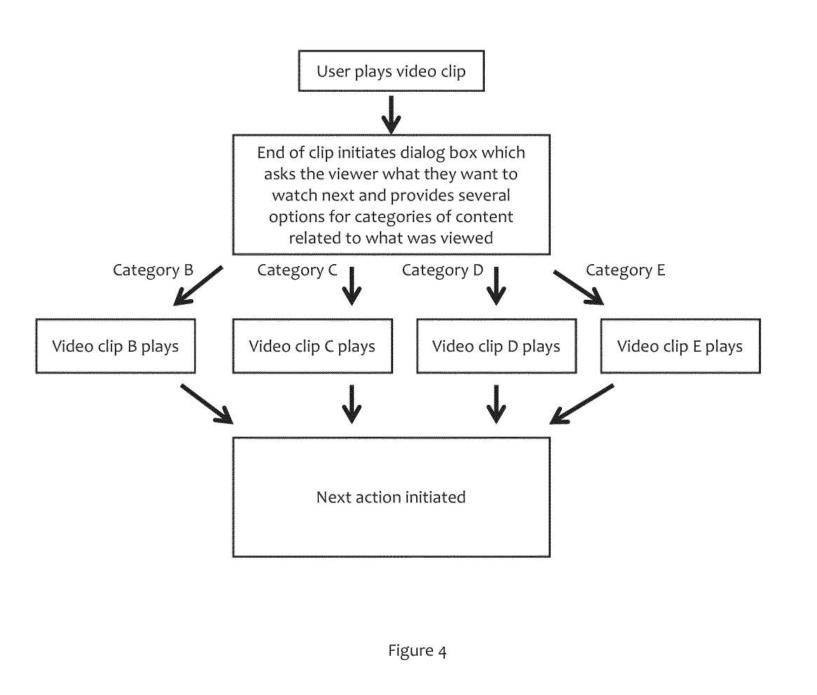

FIG. 5 is a flow diagram illustrating an external communication initiated by a video, in accordance with an embodiment.

The figures depict various embodiments of the technology for purposes of illustration only. One skilled in the art will readily recognize from the following discussion that alternative embodiments of the structures and methods illustrated herein may be employed without departing from the principles of the embodiments described herein.

### DETAILED DESCRIPTION

Various aspects of the technology allow the creator of a video (or others) to define a more immersive and/or interactive experience for the viewer of the video, by using the video itself (or playing of the video), regardless of the device on which the video is being displayed, to initiate actions beyond the video including beyond the device being used to display the video.

There is a large range of possible actions, including almost any action that is capable of being initiated by some sort of computer. Examples of some actions include altering the appearance and/or other features of the device or program displaying the video to create a more immersive experience or a more consistent experience across a range of related videos, such as videos created by the same author. A more interactive experience could also be created by using the video to initiate actions seeking input from the viewer, which input will alter what the viewer sees or what other actions occur after that point. Such input could be solicited from and provided by the viewer in a variety of ways, including by dialog boxes pop-up windows, email messages, text messages, telephone calls, social network messages, and so on. The effect of other actions that could be initiated could be to provide additional information to the viewer or to require an action by the viewer, such as sharing a hyperlink to the video, interacting with advertising, continuing viewing the video, interacting with a different device than the one showing the video, and so on. Other variations will be apparent.

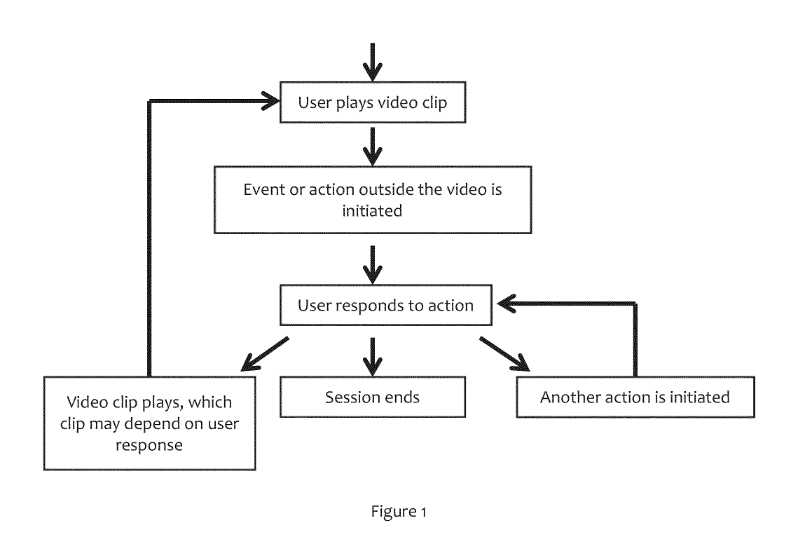

FIG. 1 is a flow diagram illustrating actions and events initiated by playing a video, in accordance with an embodiment. In FIG. 1, playing a video initiates an action or event outside the video, either with or without using context from the video. That event or action may be initiated at any or at various points during the video and can be used to provide a more immersive, interesting, and/or interactive experience for the viewer. The following embodiments and examples do not constitute an exhaustive list of the applications of technology, and they are not mutually exclusive and can be combined in various ways.

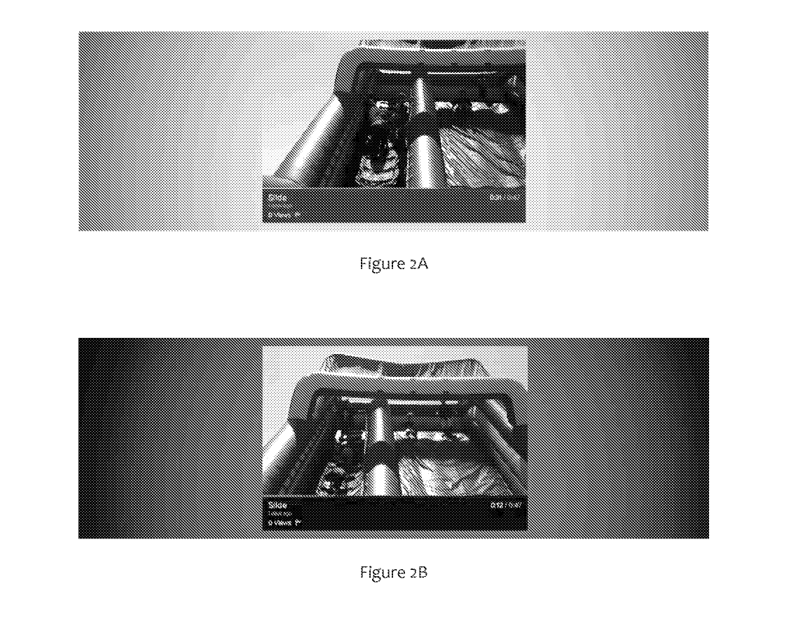

In some implementations, the action initiated by the video can make the experience more customized or consistent. For example, FIGS. 2A-2B show two screen shots of two related videos playing and demonstrate the video causing the background color adjacent to the video player to change based on image content of the video (e.g., what colors are present in the video and/or dominant in the video), thereby creating a more pleasing and immersive experience, in accordance with an embodiment. The image in FIG. 2A results in a lighter, more blue background because, in part, the sky is a significant element in the video; whereas, the image in FIG. 2B results in a darker, more purple background because of the decrease in blue and increase in red shown in the video. The background could also be changed to pre-defined colors or images based on metadata associated with the video (regardless of the video's image content), for instance to create a consistent experience across a series of different videos associated with the same author thereby helping build a brand. Changing the background is only one implementation. A non-exhaustive list of additional examples could include the video triggering the presentation of media content of any type, i.e., audio, images, text, video, and so on, to alter the viewing experience.

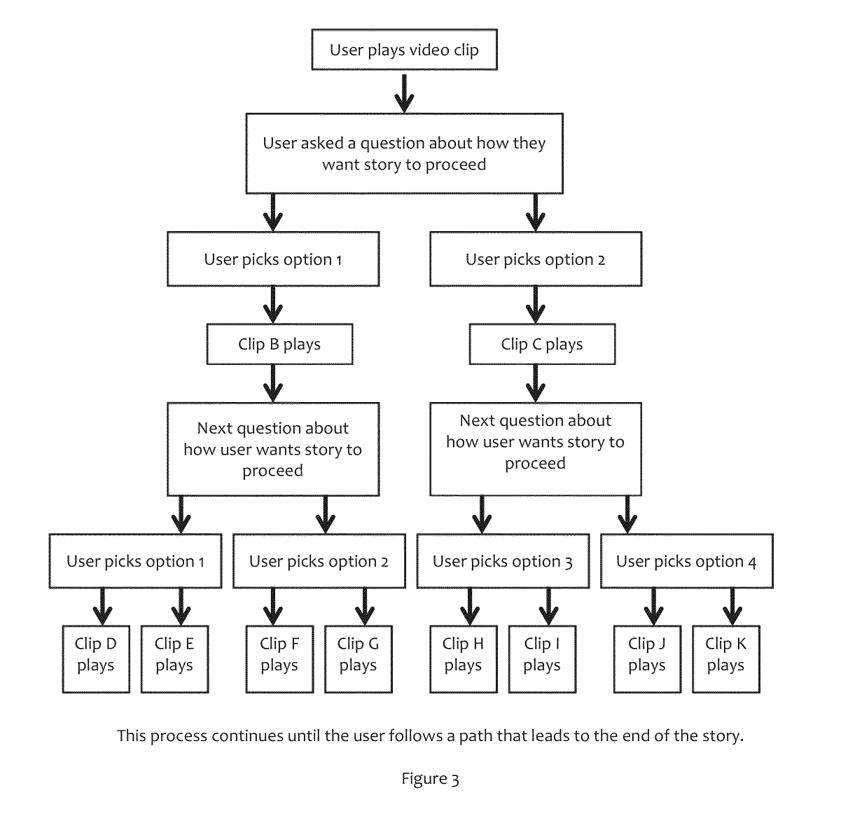

In another aspect, the action initiated by the video can allow interaction between the viewer and the video by asking a question related to the video being watched, whose answer will impact how the video progresses. A simple example of this is for the video to open a dialog box in which there is text posing a question to the viewer that the viewer can answer, and the viewer's response will impact what occurs next. For example, the question in the dialog box could relate to the content of the video being viewed and ask the viewer to choose what a character in the video should do from options provided. The viewer's selection would impact what video plays next, thereby allowing the viewer's preference to impact the story portrayed in the videos played. This process could be repeated with each clip played, thereby allowing multiple points at which the story could fork, enabling many different overall viewing experiences depending on the selections made by the viewer. FIG. 3 is a flow diagram illustrating such a “choose your own adventure” video, in accordance with an embodiment. At various points, the viewer is allowed to determine which plot path will be followed, and the videos played after such choice will reflect the choice made.

In another variation, the action initiated by the video can be used to solicit input to improve recommendations fir additional content, For instance, at the end of the video, the video might initiate an operation which would provide the viewer with a list of options for viewing similar content to that just viewed. This would allow the viewer to decide how the subsequent content should relate to what he has just viewed. For instance, at the end of a music video showing The Rolling Stones playing their song “Satisfaction,” the viewer might be asked whether they want to watch a) another Rolling Stones music video, b) another classic rock video, c) another music video from any genre, d) an interview with the Rolling Stones, e) something unrelated to the Rolling Stones, etc. The viewer's choice would impact which video played next. This process could be repeated with each subsequent video. This would create not only a more interactive experience but also a better recommendation for additional content because the recommendation would not be based just on what was previously viewed but also on active input from the viewer about what they want to see next. FIG, 4 is a flow diagram illustrating such viewer-determined content, in accordance with an embodiment.

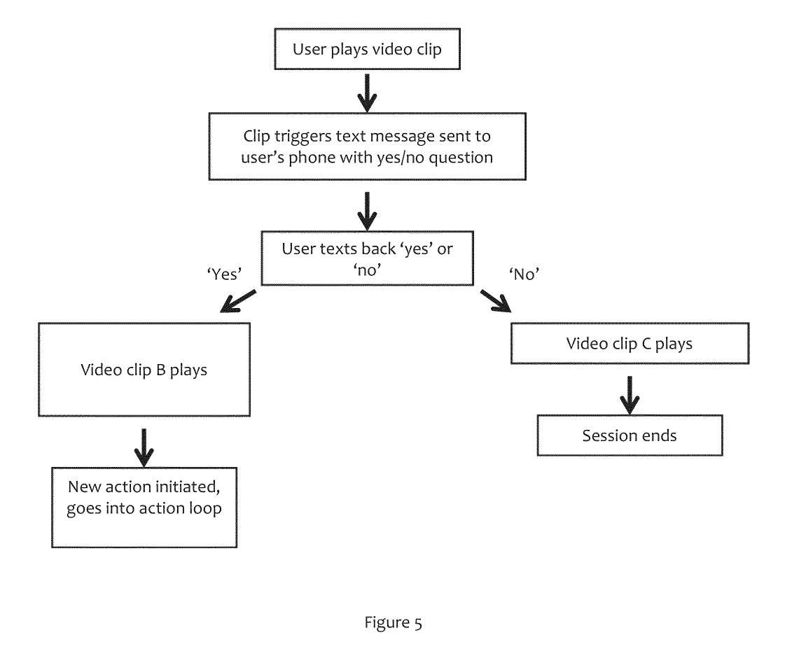

As another example, the video can initiate an event or an action that initiates contact with the viewer outside the device displaying the video. This could also include other devices. For instance, if the viewer is using a computer to watch a video in which a phone call is being made, the video might initiate a call to a telephone (landline or mobile) proximate to the viewer which, when answered, might allow the viewer to hear additional dialogue. This could be used alone to enhance the experience or, as one alternative, in combination with the dialog box option described above whereby the message the viewer hears on the telephone could contain information required to answer a question being posed in the dialog box in order to move to the next video. This could also be done by sending the viewer a photo via text message or email message and asking a question related to the photo. Another variation could be to send a text message and require a text response which would then cause the next video to play (and which video might depend on the substance of the response), in accordance with an embodiment, as shown in FIG. 5. In this example, a text message is sent to the viewer's phone. The viewer's response impacts the video played next, which could be used to create a more interactive experience.

This could also be done with email. Another use for this embodiment would be to provide the viewer helpful information related to the video. For instance, a video lesson on algebra might include an action that sends the viewer a set of problems to practice or the answer to a problem posed in the video. Another example is where the video being watched relates to a specific location, and the viewer could be sent a hyperlink to an interactive map of the location that would allow the viewer to click on various points, after which a new video would play relating to the location selected by the viewer.

The video could also initiate an action or event related to advertising. The simplest version of this might require the viewer to click on an advertising banner, perhaps being asked to pick their favorite among several or to choose the one that is most relevant to them or simply to visit the website of an advertiser, in order to continue viewing the video.

The video could also initiate an action requiring sharing the video. The video could require that the viewer share the video via a pre-defined set of social network options such as Twitter, Facebook, and Google+ prior to the remainder of the video playing, thereby increasing the potential audience for the video.

The video could also initiate an action that uses the subsequent orientation of a mobile device to determine what happens next. For instance, someone could effectively create a video maze in which the viewer can navigate through the maze by tilting their device right, left, forward, or backward at each point in which there is a decision about which direction to go shown in the video. The clip that played next would show the viewer moving in the selected direction.

As a final example, the video could initiate an action seeking media input (audio, video, or image) from the viewer and then use that input to alter the video watched next by including the input provided by the viewer. For example, an animated video might begin by requesting the viewer to record themselves saying their name or a line of dialogue which could then be dubbed in and played when the viewer watches the video.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or “determining” or the like refer to the action and processes of a computer system, or similar electronic computing device (such as a specific computing machine), that manipulates and transforms data represented as physical (electronic) quantities within the computer system memories or registers or other such information storage, transmission, or display devices.

Certain aspects of the embodiments include process steps and instructions described herein in the form of an algorithm. It should be noted that the process steps and instructions of the embodiments can be embodied in software, firmware, or hardware and, when embodied in software, could be downloaded to reside on and be operated from different platforms used by a variety of operating systems. The embodiments can also be in a computer program product which can be executed on a computing system.

The embodiments also relate to an apparatus for performing the operations herein. This apparatus may be specially constructed for the purposes, e.g. a specific computer, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The algorithms and displays presented herein re not inherently elated to any particular computer or other apparatus. Various general-purpose systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for disclosure of enablement and best mode.

In addition, the language used in the specification has been principally selected for readability and instructional purposes and may not have been selected to delineate or circumscribe the inventive subject matter. Accordingly, the disclosure of the embodiments is intended to be illustrative, but not limiting, of the scope of the embodiments, which is set forth in the claims.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments as defined in the appended claims.

What is claimed is:

1. A method for enhancing a person's video watching experience, comprising:
receiving a request to play a video;
in response to the request, using a device to play the video to the person; and
in response to playing of the video, initiating an event outside the video that is related to the video and affects the person.

2. The method of claim 1, wherein the event comprises prompting the person to perform an action.

3. The method of claim 2, wherein the action comprises providing input.

4. The method of claim 3, further comprising:
receiving input from the person;
determining a second video based on the received input; and
using the device to play the second video to the person.

5. The method of claim 3, further comprising:
receiving input from the person;
altering a second video based on the received input; and
using the device to play the altered second video to the person.

6. The method of claim 2, wherein the action comprises interacting with a second device.

7. The method of claim 2, wherein the action comprises using a social network to share a hyperlink to the video.

8. The method of claim 2, wherein the action comprises interacting with an advertisement.

9. The method of claim 1, wherein the event comprises using the device to display a background adjacent to the video.

10. The method of claim 9, further comprising determining the background based on image content of the video.

11. The method of claim 10, wherein image content of the video comprises colors present in the video.

12. The method of claim 9, further comprising determining the background based on metadata associated with the video.

13. The method of claim 12, wherein metadata associated with the video comprises an author of the video.

14. The method of claim 1, wherein the event affects a second device.

15. The method of claim 1, wherein the event comprises sending to the person a text message, an email message, or a social network message.

16. The method of claim 1, wherein the event comprises calling a telephone proximate to the person.

17. the method of claim 1, wherein the event comprises using the device to present media content e person.

18. The method of claim 1, wherein the event comprises providing information to the person.

19. A non-transitory computer-readable storage medium storing computer program modules for enhancing a person's video watching experience, the computer program modules executable to perform steps comprising:
receiving a request to play a video;
in response to the request, using a device to play the video to the person; and
in response to playing of the video, initiating an event outside the video that is related to the video and affects the person.

20. A system for enhancing a person's video watching experience, the system comprising:
a non-transitory computer-readable storage medium storing computer program modules executable to perform steps comprising:
receiving a request to play a video;
in response to the request, using a device to play the video to the person; and
in response to playing of the video, initiating an event outside the video that is related to the video and affects the person; and
a computer processor for executing the computer program modules.
